(19) United States
(12) Patent Application Publication
(10) Pub. No.: US 2020/0247000 A1
(43) Pub. Date: Aug. 6, 2020

(54) Compositions of Wood Restorer with Stain and Methods Thereof

(71) Applicant: Scotch Corporation, Dallas, TX (US)

(72) Inventors: Mark Greenberg, Dallas, TX (US); James O. Wright, II, Mesquite, TX (US)

(73) Assignee: Scotch Corporation, Dallas, TX (US)

(21) Appl. No.: 16/777,433

(22) Filed: Jan. 30, 2020

Related U.S. Application Data
(60) Provisional application No. 62/802,119, filed on Feb. 6, 2019.

(51) Int. Cl. B27K 3/34; C09D 15/00; B27K 3/02; C08L 25/14; C08L 23/06

(52) U.S. Cl. CPC B27K 3/34; C09D 15/00; B27K 3/0207; C08L 25/14; C08K 5/06; C08L 2207/062; C08L 2205/03; C08L 2201/52; C08L 23/06

(57) ABSTRACT

A composition for a wood restorer with a stain, the composition comprising: a polymer emulsion, wherein the polymer emulsion comprises a styrene acrylic copolymer emulsion and a high density polyethylene emulsion, a stain, and a first water, wherein the first water forms the balance of the composition. A method of using the composition to cleanse a wood surface is also disclosed.

### PRIOR RELATED APPLICATIONS

This application claims benefit of and priority to U.S. Provisional Patent Application No. 62/802,119 entitled “COMPOSITIONS OF WOOD RESTORER WITH STAIN AND METHODS THEREOF,” filed on Feb. 6, 2019, the entire disclosure of which is incorporated by reference herein in its entirety.

### FEDERALLY SPONSORED RESEARCH STATEMENT

Not Applicable (“N/A”)

### REFERENCE TO MICROFICHE APPENDIX

N/A

### FIELD OF INVENTION

The invention relates to a wood restorer with a stain and methods thereof, and, in particular, to compositions of a wood floor restorer with a stain and methods thereof.

### BACKGROUND OF THE INVENTION

Wood flooring and wood furniture can be expensive. Over time, the surfaces of wood flooring and wood furniture can accumulate surface scratches. If the surface scratches could be covered, the wood surface could look nearly new again.

Most wood care products either cleanse or polish wood surfaces. These products do not typically contain wood stains or varnishes so they do not cover the scratches.

Wood stain and varnish products can restore a wood surface. However, these products generally require significant surface preparation to remove (e.g., strip and/or sand) any old stain or varnish layers from the wood surface before applying the products.

Therefore, there is a need for a wood restorer with a stain that does not require significant surface preparation to remove any old stain or varnish layers from the wood surface.

### SUMMARY OF THE INVENTION

The present invention provides a wood restorer with a stain and methods thereof, and, in particular, to compositions of a wood floor restorer with a stain and methods thereof.

In an embodiment, a composition for a wood restorer with a stain, the composition comprises a polymer emulsion, wherein the polymer emulsion comprises a styrene acrylic copolymer emulsion and a high density polyethylene emulsion, a stain, and a first water, wherein the first water forms the balance of the composition.

In an embodiment, the composition for the wood restorer further comprises from about 1 weight percent to about 50 weight percent of the polymer emulsion, from about 0.1 weight percent to about 10 weight percent of the stain, and from about 50 weight percent to about 99 weight percent of the first water.

In an embodiment, the polymer emulsion comprises from about 1 weight percent to about 45 weight percent of the styrene acrylic copolymer emulsion and from about 0.5 weight percent to about 5 weight percent of a high density polyethylene wax emulsion.

In an embodiment, the styrene acrylic copolymer emulsion comprises from about 1 weight percent to about 30 weight percent of styrene polymer, from about 1 weight percent to about 30 weight percent of methyl methacrylate polymer, from about 1 weight percent to about 30 weight percent of butyl acrylate, ethyl acrylate, 2-ethylhexyl acrylate, and combinations thereof, from 0.5 weight percent to about 5 weight percent of methyl acrylic acid, and from about 50 weight percent to about 80 weight percent of second water.

In an embodiment, the high density polyethylene wax emulsion comprises from about 5 weight percent to about 60 weight percent of a high density polyethylene wax, from about 1 weight percent to about 20 weight percent of one or more ethoxylated C12-C15 alcohols and from about 50 weight percent to about 80 weight percent of a third water.

In an embodiment, the polymer emulsion is selected from the group consisting of an Omnova™ Mor-Glo™ 877 or equivalent, an Omnova™ Mor-Shine 4U™ or equivalent, Omonva™ Mor-Shine E™ or equivalent, Mor-Flo™ WE-30 or equivalent, and combinations thereof.

In an embodiment, the wood restorer comprises a stain.

In an embodiment, the stain comprises a pigment. In an embodiment, the stain comprises a black pigment. In an embodiment, the stain comprises a brown pigment. In an embodiment, the stain comprises a brown pigment and a green pigment.

In an embodiment, the stain comprises a white pigment, a black pigment, a phthalo blue pigment, a phthalo green pigment, an azo yellow pigment, a trans yellow oxide pigment, a yellow iron oxide pigment, a red iron oxide pigment, a trans red oxide pigment, a naphthol red pigment, a perylene red pigment, a quindo red pigment, and combinations thereof.

In an embodiment, the stain comprises an exterior white pigment, an IR black YS pigment, a 775 IR black pigment, an IRR black 03 pigment, an IRR black 74 pigment, a black IRR pigment, a brown IR pigment, a cobalt green IRR pigment, a Kelly green IRR pigment, a high IR green pigment, a red IRR pigment, a yellow IRR pigment, a golden yellow IRR pigment, and combinations thereof.

In an embodiment, the wood restorer comprises from about 0.2 weight percent to about 20 weight percent of the stain. In an embodiment, the composition comprises from about 0.1 weight percent to about 10 weight percent of the stain. In an embodiment, the composition comprises from about 0.5 weight percent to about 5 weight percent of the stain.

In an embodiment, the wood restorer comprises a first water.

In an embodiment, the first water is tap water. In an embodiment, the first water is purified water. In an embodiment, the first water is Omnova™ Purified Water.

In an embodiment, the first water is selected from the group consisting of distilled water, Omnova™ Purified Water or equivalent, potable water, purified water, tap water, well water, and combinations thereof.

In an embodiment, the wood restorer further comprises an additive.

In an embodiment, the additive is selected from the group consisting of an antibacterial agent, a defoamer, a fast-acting solvent, a flame retardant, a plasticizer, a surfactant and combinations thereof.

In an embodiment, the wood restorer further comprises a surfactant.

In an embodiment, the surfactant is selected from the group consisting of Omnova Polyfox™ PF-136A or equivalent, Omnova™ Polyfox™ PF-156A or equivalent, Omnova™ Polyfox™ PF-2002 or equivalent, Omnova™ Polyfox™ PF-2003 or equivalent, and combinations thereof.

In an embodiment, the polymer emulsion further comprises from about 0.5 weight percent to about 5 weight percent of a surfactant.

In an embodiment, the wood restorer further comprises from about 0.001 weight percent to about 0.5 weight percent of a surfactant.

In an embodiment, the surfactant comprises from about 5 weight percent to about 50 weight percent of an active anionic fluorinated polyether diammonium, from about 3 weight percent to about 30 weight percent of dipropylene glycol methyl ether, from about 3 weight percent to about 30 weight percent of diethylene glycol monobutyl ether and from about 20 weight percent to about 60 weight percent of a fourth water.

In an embodiment, the wood restorer further comprises an antibacterial agent.

In an embodiment, the antibacterial agent comprises 1,2-benzisothiazolin-3-one, zinc pyriththione, and combinations thereof.

In an embodiment, the antibacterial agent is selected from the group consisting of Proxel® BZ or equivalent, Proxel® BZ Plus or equivalent, Proxel® DL or equivalent, Proxel® GXL or equivalent, and combinations thereof.

In an embodiment, the wood restorer further comprises from about 0.001 weight percent to about 0.5 weight percent of an antibacterial agent.

In an embodiment, the antibacterial agent comprises from about 10 weight percent to about 30 weight percent of 1,2-benzisothiazolin-3-one, from about 0.5 weight percent to about 5 weight percent of dipropylene glycol, from about 5 weight percent to about 15 weight percent of sodium hydroxide and from about 50 weight percent to about 99 weight percent of a fifth water.

In an embodiment, the wood restorer further comprises a defoamer.

In an embodiment, the defoamer comprises polymethylsiloxane.

In an embodiment, the defoamer is selected from the group consisting of Silfoam® SE-21 or equivalent.

In an embodiment, the wood restorer further comprises from about 0.001 to about 0.5 weight percent of a defoamer.

In an embodiment, the defoamer comprises from about 2 weight percent to about 20 weight percent of a polymethylsiloxane and from about 80 weight percent to about 98 weight percent of a sixth water.

In an embodiment, the wood restorer further comprises a flame retardant.

In an embodiment, the flame retardant comprises tris (2-butoxyethyl) phosphate.

In an embodiment, the flame retardant is selected from the group consisting of KP-140 or equivalent.

In an embodiment, the wood restorer further comprises from about 0.001 weight percent to about 1 weight percent of a flame retardant.

In an embodiment, the flame retardant comprises from 0.001 weight percent to about 1 weight percent of tris (2-butoxyethyl) phosphate.

In an embodiment, the wood restorer further comprises a plasticizer.

In an embodiment, the plasticizer comprises diethylene glycol monoethyl ether.

In an embodiment, the plasticizer is selected from the group consisting of Dow® Carbitol™ LG or equivalent.

In an embodiment, the wood restorer further comprises from about 0.001 weight percent to about 1 weight percent of a plasticizer.

In an embodiment, the wood restorer further comprises from about 0.001 weight percent to about 1 weight percent of diethylene glycol monoethyl ether.

In an embodiment, the wood restorer further comprises a fast-acting solvent.

In an embodiment, the fact acting solvent comprises diethylene glycol monoethyl ether.

In an embodiment, the fast-acting solvent is selected from the group consisting of Dow® Carbitol™ LG or equivalent.

In an embodiment, the wood restorer further comprises from about 0.001 weight percent to about 1 weight percent of a fast acting solvent.

In an embodiment, the wood restorer further comprises from about 0.001 weight percent to about 1 weight percent of diethylene glycol monoethyl ether.

In an embodiment, a method of using a composition for a wood restorer with a stain, the method comprising a) providing a composition as discussed herein, b) dusting a wood surface and/or mopping the wood surface with clean water to form a cleaned wood surface, and c) wiping the cleaned wood surface with the composition to cleanse and rejuvenate the cleaned wood surface.

In an embodiment, step b) comprises dusting the wood surface with a dust rag and/or wiping mopping the wood surface with a clean, water-dampened cloth to form the cleaned surface.

In an embodiment, step c) comprises wiping the cleaned wood surface with a clean, composition-dampened cloth to cleanse and rejuvenate the cleaned wood surface.

In an embodiment, the wood surface has a scratch.

In an embodiment, the composition as discussed herein reduces the appearance of the scratch.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of a required fee.

For a further understanding of the nature and objects of the present invention, reference should be made to the following detailed disclosure, taken in conjunction with the accompanying drawings, in which like parts are given like reference numerals, and wherein:

FIG. 1 illustrates a composition of a wood restorer with a stain comprising about 0.61 weight percent of a black pigment;

FIG. 2 illustrates a composition of a wood restorer with a stain comprising about 0.21 weight percent of a brown pigment;

FIG. 3 illustrates a composition of a wood restorer with a stain comprising about 0.15 weight percent of a black pigment;

FIG. 4 illustrates a composition of a wood restorer with a stain comprising about 0.32 weight percent of a brown pigment and about 0.08 weight percent of a green pigment;

FIGS. 5A-5B illustrate a composition of a wood restorer with a stain comprising about 0.39 weight percent of a brown pigment;

FIGS. 6A-6C illustrate a composition of a wood restorer with a stain comprising about 0.31 weight percent of a brown pigment and about 0.08 weight percent of a green pigment;

FIGS. 7A-7B illustrate a method of using a composition of a wood restorer with a stain to cleanse and rejuvenate a wood surface;

FIG. 8A illustrates a photograph of a wood surface with a scratch after using a composition of a wood restorer with a stain, showing a reduction in appearance of the scratch;

FIG. 8B illustrates a magnified image of the scratch of FIG. 8A, showing a reduction in appearance of the scratch;

FIG. 8C illustrates a scanning electron microscope (SEM) image of the scratch of FIGS. 8A-8B; and

FIG. 9 illustrates a wood surface before and after repeatedly using a composition of a wood restorer with a stain.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

### Composition

### Examples 1 and 3 (with Black Pigment)

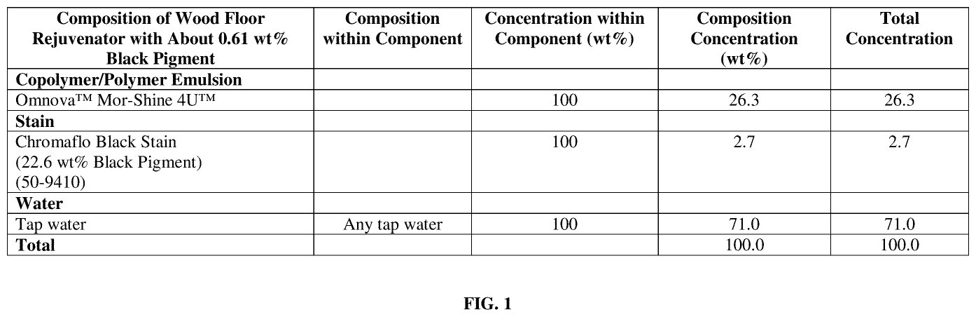

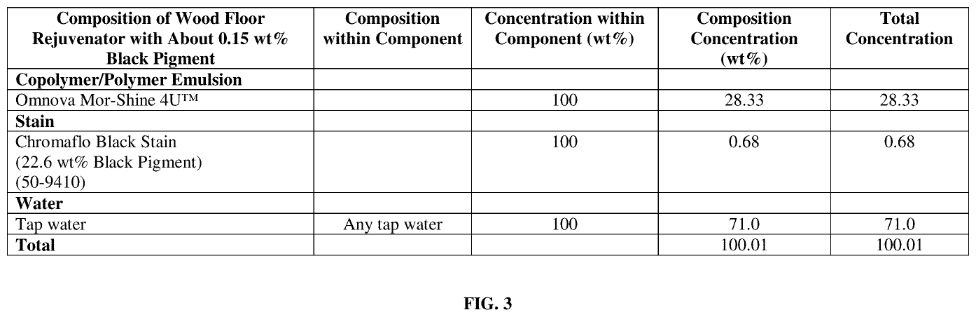

FIG. 1 illustrates a composition of a wood restorer with a stain comprising about 0.61 weight percent of a black pigment (Example 1); and FIG. 3 illustrates a composition of a wood restorer with a stain comprising about 0.15 weight percent of a black pigment (Example 3).

### Examples 2 and 4 (with Brown Pigments)

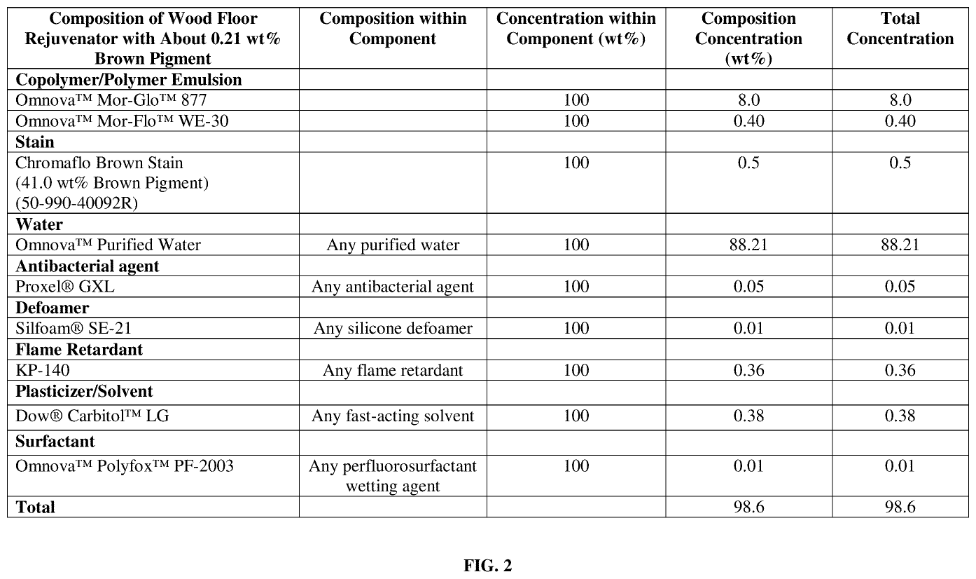

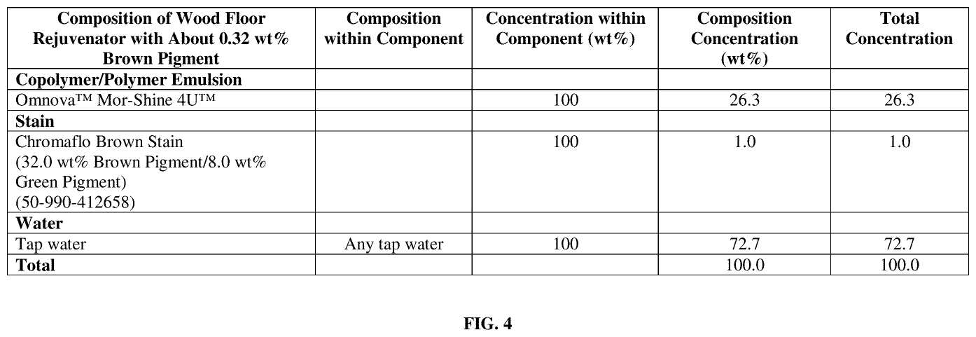

FIG. 2 illustrates a composition of a wood restorer with a stain comprising about 0.21 weight percent of a brown pigment (Example 2); and FIG. 4 illustrates a composition of a wood restorer with a stain comprising about 0.32 weight percent of a brown pigment and about 0.08 weight percent of a green pigment (Example 4).

As shown in FIGS. 1-4, the wood restorer may comprise a polymer emulsion, a stain and water.

Polymer Emulsion

In an embodiment, the wood restorer may comprise from about 1 weight percent to about 50 weight percent of a polymer emulsion, and any range or value there between. In an embodiment, the wood restorer may comprise about 26.3 weight percent of a polymer emulsion. (See e.g., FIGS. 1 & 4). In an embodiment, the wood restorer may comprise about 28.3 weight percent of a polymer emulsion. (See e.g., FIG. 3).

The polymer emulsion may be any suitable polymer emulsions. For example, a suitable polymer emulsion includes, but is not limited to, Omnova™ Mor-Shine 4U styrene acrylic copolymer emulsion or equivalent, Omnova™ Mor-Glo™ 877 styrene acrylic copolymer emulsion or equivalent, Omnova™ Mor-Flo™ WE-30 high density polyethylene wax emulsion or equivalent, and combinations thereof.

In an embodiment, the wood restorer may comprise from about 1 weight percent to about 50 weight percent of a styrene acrylic copolymer emulsion, and any range or value there between. (See e.g., FIGS. 1 & 3-4). In an embodiment, the wood restorer may comprise about 26.3 weight percent of a styrene acrylic copolymer emulsion. (See e.g., FIGS. 1 & 4). In an embodiment, the wood restorer may comprise about 28.3 weight percent of a styrene acrylic copolymer emulsion. (See e.g., FIG. 3).

In an embodiment, the wood restorer may comprise from about 1 weight percent to about 50 weight percent of a styrene acrylic copolymer emulsion, and any range or value there between, and from about 0.5 to about 5 weight percent of a polyethylene wax emulsion, and any range or value there between. (See e.g., FIG. 2). In an embodiment, the wood restorer may comprise about 8 weight percent of a styrene acrylic copolymer emulsion and about 0.40 weight percent of a polyethylene wax emulsion. (See e.g., FIG. 2).

Stain

In an embodiment, the wood restorer may comprise from about 0.2 weight percent to about 20 weight percent of a stain, and any range or value there between. In an embodiment, the wood restorer may comprise from about 0.1 weight percent to about 10 weight percent of a stain, and any range or value there between. In an embodiment, the wood restorer may comprise from about 0.5 weight percent to about 5 weight percent of a stain, and any range or value there between. In an embodiment, the wood restorer may comprise about 2.7 weight percent of a stain. (See e.g., FIG. 1). In an embodiment, the wood restorer may comprise about 1 weight percent of a stain. (See e.g., FIG. 1). In an embodiment, the wood restorer may comprise about 0.7 weight percent of a stain. (See e.g., FIG. 3). In an embodiment, the wood restorer may comprise about 0.5 weight percent of a stain. (See e.g., FIG. 2).

The stain may be any suitable stain. For example, a suitable stain includes, but is not limited to, a Chromaflo™ 50-9400 series stain (see Table 1) or equivalent, a Chromaflo™ 50-990 series stain (see Table 2) or equivalent, and combinations thereof.

TABLE 1
Chromaflo 50-9400 Series Technical Data¹

| | | | | | Volatile |
|---|---|---|---|---|---|
| | | | | | Organic |
| | | | | | Com- |
| Chromaflo ™ | | Pigment | Resin | Water | pounds |
| Product Code | Description | (wt %) | (wt %) | (wt %) | (wt %) |
| 50-9401 | White (Wh 6) | 61.6 | 7.2 | 27.7 | 3.5 |
| 50-9410 | Black (Bk 7) | 22.6 | 14.0 | 59.0 | 4.4 |
| 50-9470 | Phthalo Blue | 30.8 | 12.1 | 51.9 | 5.2 |
| | RS (B1 15:2) | | | | |
| 50-9462 | Phthalo Green | 36.5 | 13.7 | 45.5 | 4.3 |
| | BS (G 7) | | | | |
| 50-9449 | Azo Yellow | 35.0 | 13.6 | 47.1 | 4.3 |
| | (Y 74) | | | | |
| 50-9418 | 3G Yellow | 27.4 | 16.1 | 51.5 | 4.9 |
| | (Y 93) | | | | |
| 50-9429 | Trans Yellow | 27.0 | 13.6 | 54.9 | 4.4 |
| | Oxide (Y 42) | | | | |
| 50-9457 | Yellow Iron | 49.0 | 10.3 | 37.0 | 3.7 |
| | Oxide (Y 42) | | | | |
| 50-9459 | Red Iron | 51.6 | 9.6 | 35.2 | 3.6 |
| | Oxide (R 101) | | | | |
| 50-9430 | Trans Red | 30.6 | 15.5 | 48.9 | 5.1 |
| | Oxide (R 101) | | | | |
| 50-9423 | Naphthol Red | 41.9 | 8.7 | 47.3 | 2.1 |
| | (R 170) | | | | |
| 50-9438 | Perylene Red | 28.0 | 12.2 | 55.1 | 4.7 |
| | (R 190) | | | | |
| 50-9434 | Quindo Red | 32.0 | 12.5 | 51.8 | 3.7 |
| | YS (V 19) | | | | |

¹Chromaflo Technologies, CHROMA-CHEM ® 50-9400 Pigment Dispersions for Water-Based Coatings (March 2014)

TABLE 2
Chromaflo ™ 50-990 Series Technical Data²

| Chromaflo ™ | | Pigment | Nonvolatiles | Water |
|---|---|---|---|---|
| Product Code | Description | (wt %) | (wt %) | (wt %) |
| 50-990-151 | Exterior White | 64.1 | 3.3 | 32.6 |
| 50-990-02296R | IR Black YS | 68.7 | 7.8 | 23.5 |
| 50-990-02355R | 775 IR Black | 73.7 | 7.9 | 18.5 |
| 50-990-02358R | IRR Black 03 | 68.7 | 7.8 | 23.5 |
| 50-990-02364R | IRR Black 74 | 68.7 | 8.0 | 23.3 |
| 50-990-20957R | Black IRR | 68.4 | 8.3 | 23.3 |
| 50-990-20968R | Black IRR | 24.7 | 7.3 | 68.0 |
| 50-990-40092R | Brown IR | 41.0 | 6.7 | 52.3 |
| 50-990-50186R | Cobalt Green IRR | 68.8 | 8.2 | 23.0 |
| 50-990-50197R | Kelly Green IRR | 64.5 | 7.5 | 28.0 |
| 50-990-50214R | High IR Green | 63.8 | 6.3 | 27.9 |
| 50-990-70567R | Red IRR | 59.2 | 12.1 | 27.7 |
| 50-990-80486R | Yellow IRR | 57.0 | 9.0 | 33.8 |
| 50-990-80487R | Golden Yellow IRR | 64.6 | 10.8 | 24.6 |

²Chromaflo Technologies, CHROMAPCHEM ® 50-990 IR Reflective Pigment Dispersions for IR Reflective Coatings (March 2014)

In an embodiment, the wood restorer may comprise a Chromaflo™ Black Stain (50-9410) or equivalent. (See e.g., FIGS. 1 & 3). In an embodiment, the Chromaflo™ Black Stain (50-9410) may comprise about 22.6 weight percent of black pigment, about 14.0 weight percent of resin, about 59 weight percent of water, and about 4.4 weight percent of volatile organic compounds. (See e.g., Table 1).

In an embodiment, the wood restorer may comprise a Chromaflo™ Brown Stain (50-990-40092R) or equivalent. (See e.g., FIG. 2). In an embodiment, the Chromaflo™ Brown Stain (50-990-40092R) may comprise about 41.0 weight percent of brown pigment, about 6.7 weight percent of nonvolatiles, about 52.3 weight percent of water. (See e.g., Table 2).

In an embodiment, the wood restorer may comprise a Chromaflo™ Brown Stain (50-990-412658) or equivalent. (See e.g., FIG. 4). In an embodiment, Chromaflo™ Brown Stain (50-990-412658) may comprise about 32.0 weight percent of brown pigment, about 8.0 weight percent of green pigment, about 20.0 weight percent of nonvolatiles, and about 40.0 weight percent of water.

In an embodiment, the wood restorer may comprise from about 0.1 to about 1 weight percent of pigment, and any range or value there between. In an embodiment, the wood restorer may comprise about 0.6 weight percent pigment. (See e.g., FIG. 1). In an embodiment, the wood restorer may comprise about 0.3 weight percent pigment. (See e.g., FIG. 4). In an embodiment, the wood restorer may comprise about 0.2 weight percent pigment. (See e.g., FIG. 2). In an embodiment, the wood restorer may comprise about 0.15 weight percent pigment. (See e.g., FIG. 3).

Water Balance

In an embodiment, the wood restorer may comprise from about 50 to about 98 weight percent of water, and any range or value there between. In an embodiment, the wood restorer may comprise about 71 weight percent or about 72.7 weight percent of water (not including any water from polymer emulsion). (See e.g., FIGS. 1 & 3-4). In an embodiment, the wood restorer may comprise about 88.2 weight percent of water (not including any water from polymer emulsion). (See e.g., FIG. 2).

The water may be any suitable water. For example, a suitable water includes, but is not limited to, distilled water, potable water, purified water, and combinations thereof. In an embodiment, the wood restorer comprises tap water. (See e.g., FIGS. 1 & 3-4). In an embodiment, the wood restorer comprises purified water. (See e.g., FIG. 2).

In an embodiment, the wood restorer may comprise Omnova™ Purified Water. (See e.g., FIG. 2).

In an embodiment, the wood restorer may comprise from about 50 to about 98 weight percent of tap water and/or purified water, and any range or value there between. In an embodiment, the wood restorer may comprise about 71 weight percent or about 72.7 weight percent of tap water (not including any water from other components). (See e.g., FIGS. 1 & 3-4). In an embodiment, the wood restorer may comprise about 88.2 weight percent of purified water (not including any water from other components). (See e.g., FIG. 2). In an embodiment, the wood restorer may comprise about 88.2 weight percent of Omnova™ Purified Water (not including any water from other components). (See e.g., FIG. 2).

Additives

In an embodiment, the wood restorer may further comprise one or more additives.

The additives may be any suitable additives. For example, suitable additives include, but are not limited to, any antibacterial agent, any defoamer, any flame retardant, any plasticizer, any fast-acting solvent, any surfactant, and combinations thereof. (See e.g., FIG. 2).

In an embodiment, the wood restorer may further comprise an antibacterial agent. In an embodiment, the wood restorer may further comprise from about 0.001 weight percent to about 1 weight percent of an antibacterial agent, and any range or value there between. In an embodiment, the wood restorer may further comprise about 0.05 weight percent of an antibacterial agent.

The antibacterial agent may be any suitable antibacterial agent. For example, a suitable antibacterial agent includes, but is not limited to, a Proxel® GXL antibacterial agent or equivalent. In an embodiment, the wood restorer may further comprise from about 0.001 weight percent to about 1 weight percent of a Proxel® GXL antibacterial agent, and any range or value there between. In an embodiment, the wood restorer may further comprise about 0.05 weight percent of an Proxel® GXL antibacterial agent. (See e.g., FIG. 2).

In an embodiment, the wood restorer may further comprise a defoamer. In an embodiment, the wood restorer may further comprise from about 0.001 weight percent to about 1 weight percent of a defoamer, and any range or value there between. In an embodiment, the wood restorer may further comprise about 0.01 weight percent of a defoamer.

The defoamer may be any suitable defoamer. For example, a suitable defoamer includes, but is not limited to, a Silfoam® SE-21 silicone defoamer or equivalent. In an embodiment, the wood restorer may further comprise from about 0.001 weight percent to about 1 weight percent of a Silfoam® SE-21 silicone defoamer, and any range or value there between. In an embodiment, the wood restorer may further comprise about 0.01 weight percent of a Silfoam® SE-21 silicone defoamer. (See e.g., FIG. 2).

In an embodiment, the wood restorer may further comprise a flame retardant. In an embodiment, the wood restorer may further comprise from about 0.001 weight percent to about 1 weight percent of a flame retardant, and any range or value there between. In an embodiment, the wood restorer may further comprise about 0.36 weight percent of a flame retardant. (See e.g., FIG. 2).

The flame retardant may be any suitable flame retardant. For example, a suitable flame retardant includes, but is not limited to, a KP-140 flame retardant or equivalent. In an embodiment, the wood restorer may further comprise from about 0.001 weight percent to about 1 weight percent of a KP-140 flame retardant, and any range or value there between. In an embodiment, the wood restorer may further comprise about 0.36 weight percent of a KP-140 flame retardant. (See e.g., FIG. 2).

In an embodiment, the wood restorer may further comprise a plasticizer. In an embodiment, the wood restorer may further comprise from about 0.001 weight percent to about 1 weight percent of a plasticizer, and any range or value there between. In an embodiment, the wood restorer may further comprise about 0.36 weight percent of a plasticizer. (See e.g., FIG. 2).

The plasticizer may be any suitable plasticizer. For example, a suitable plasticizer includes, but is not limited to, a Dow® Carbitol™ LP plasticizer or equivalent. In an embodiment, the wood restorer may further comprise from about 0.001 weight percent to about 1 weight percent of a Dow® Carbitol™ LP plasticizer, and any range of value there between. In an embodiment, the wood restorer may further comprise about 0.36 weight percent of a Dow® Carbitol™ LP plasticizer. (See e.g., FIG. 2).

In an embodiment, the wood restorer may further comprise a solvent. In an embodiment, the wood restorer may further comprise from about 0.001 weight percent to about 1 weight percent of a solvent, and any range or value there between. In an embodiment, the wood restorer may further comprise about 0.38 weight percent of a solvent. (See e.g., FIG. 2).

The solvent may be any suitable fact-acting solvent. For example, a suitable fast-acting solvent includes, but is not limited to, a Dow® Carbitol™ LG fast-acting solvent or equivalent. In an embodiment, the wood restorer may further comprise from about 0.001 weight percent to about 1 weight percent of a Dow® Carbitol™ LG fast-acting solvent, and any range or value there between. In an embodiment, the wood restorer may further comprise about 0.38 weight percent of a Dow® Carbitol™ LG fast-acting solvent. (See e.g., FIG. 2).

In an embodiment, the wood restorer may further comprise a surfactant. In an embodiment, the wood restorer may further comprise from about 0.001 weight percent to about 1 weight percent of a surfactant, and any range or value there between. In an embodiment, the wood restorer may further comprise about 0.01 weight percent of a surfactant. (See e.g., FIG. 2).

The surfactant may be any suitable perfluorosurfactant wetting agent. For example, a suitable surfactant includes, but is not limited to, a Omnova™ Polyfox™ PF-2003 surfactant or equivalent. In an embodiment, the wood restorer may further comprise from about 0.001 weight percent to about 1 weight percent of a Omnova™ Polyfox™ PF-2003 surfactant, and range or value there between. In an embodiment, the wood restorer may further comprise about 0.01 weight percent of an Omnova™ Polyfox™ PF-2003 surfactant. (See e.g., FIG. 2).

### Examples 5 and 6 (with a Brown Pigment)

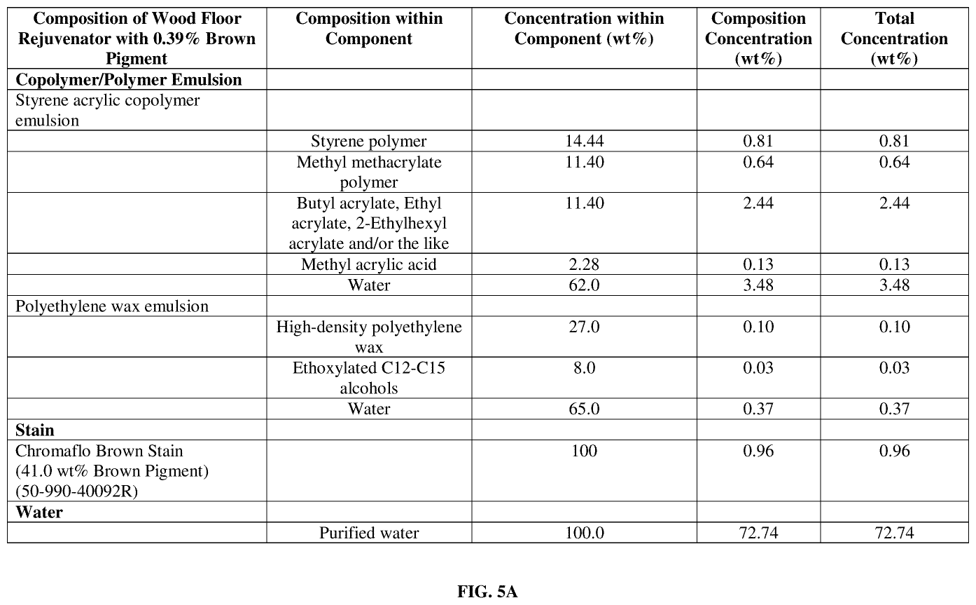

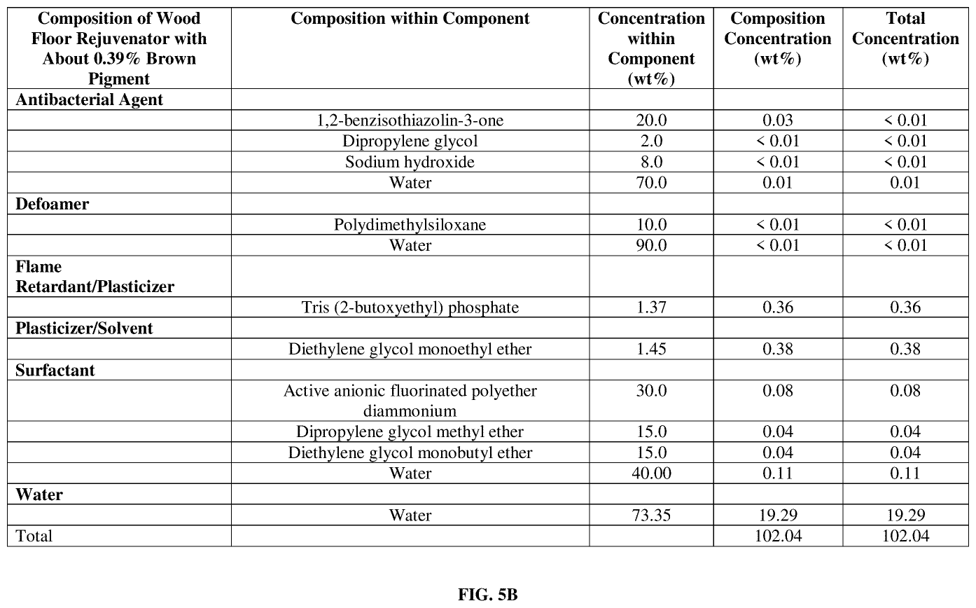

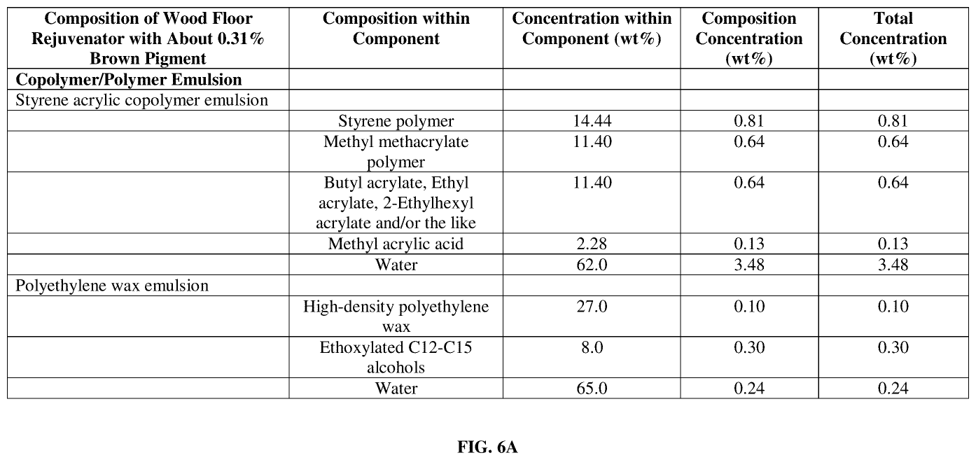

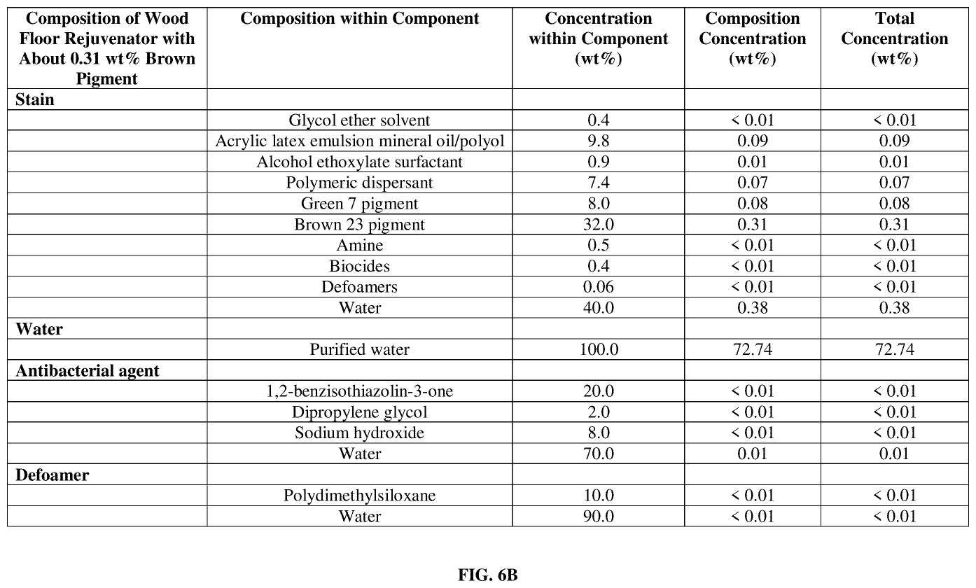

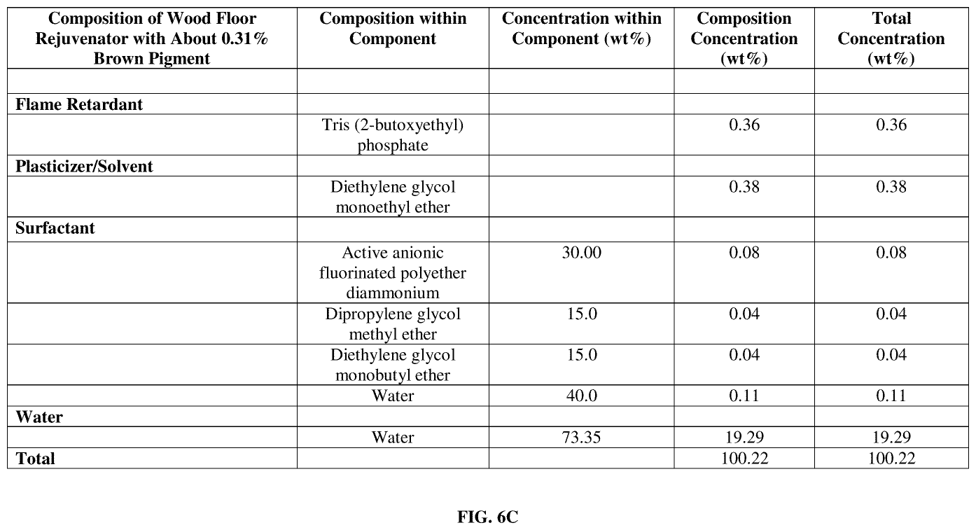

FIGS. 5A-5B illustrate a composition of a wood restorer with a stain comprising about 0.39 weight percent of a brown pigment (Example 5); and FIGS. 6A-6C illustrate a composition of a wood restorer with a stain comprising about 0.31 weight percent of a brown pigment and about 0.08 weight percent of a green pigment (Example 6). As shown in FIGS. 5A-5B and 6A-6C, the wood restorer may comprise a polymer emulsion, a stain and water.

Polymer Emulsion

In an embodiment, the wood restorer may comprise from about 1 weight percent to about 30 weight percent of a polymer emulsion, and any range or value there between. In an embodiment, the wood restorer may comprise about 26.3 weight percent of a polymer emulsion. (See e.g., FIGS. 1 & 4-6C). In an embodiment, the wood restorer may comprise about 28.3 weight percent of a polymer emulsion. (See e.g., FIG. 3).

The polymer emulsion may be any suitable polymer emulsion. For example, a suitable polymer emulsion includes, but is not limited to, Omnova™ Mor-Shine 4U styrene acrylic copolymer emulsion or equivalent, Omnova™ Mor-Glo 877 styrene acrylic copolymer emulsion or equivalent, Omnova™ Mor-Flo WE-30 high density polyethylene wax emulsion or equivalent, and combinations thereof.

In an embodiment, the wood restorer may comprise from about 1 weight percent to about 50 weight percent of a styrene acrylic copolymer emulsion, and any range or value there between. (See e.g., FIGS. 1 & 3-4). In an embodiment, the wood restorer may comprise about 26.3 weight percent of a styrene acrylic copolymer emulsion. (See e.g., FIGS. 1 & 4-6C). In an embodiment, the wood restorer may comprise about 28.3 weight percent of a styrene acrylic copolymer emulsion. (See e.g., FIG. 3).

In an embodiment, the wood restorer may comprise from about 1 weight percent to about 50 weight percent of a styrene acrylic copolymer emulsion, and any range or value there between, and from about 0.001 to about 5 weight percent of a polyethylene wax emulsion, and any range or value there between. (See e.g., FIG. 2). In an embodiment, the wood restorer may comprise about 8.0 weight percent of a styrene acrylic copolymer emulsion and about 0.4 weight percent of a polyethylene wax emulsion. (See e.g., FIG. 2). In an embodiment, the wood restorer may comprise about 21.4 weight percent of a styrene acrylic copolymer emulsion and about 1.4 weight percent of a polyethylene wax emulsion. (See e.g., FIGS. 5A-5B & 6A-6C).

In an embodiment, the styrene acrylic copolymer emulsion may comprise styrene polymer, methyl methacrylate polymer, butyl acrylate, ethyl acrylate, 2-ethylhexyl acrylate, methylacrylic acid, water, and combinations thereof. (See e.g., FIGS. 5A-5B & 6A-6C).

In an embodiment, the styrene acrylic copolymer emulsion may comprise from about 1 weight percent to about 50 weight percent of styrene polymer, and any range or value there between. In an embodiment, the styrene acrylic copolymer emulsion may comprise about 14.44 weight percent of styrene polymer. (See e.g., FIGS. 5A-5B & 6A-6C).

In an embodiment, the styrene acrylic copolymer emulsion may comprise from about 1 weight percent to about 50 weight percent of methyl methacrylate polymer, and any range or value there between. In an embodiment, the styrene acrylic copolymer emulsion may comprise about 11.40 weight percent of methyl methacrylate polymer. (See e.g., FIGS. 5A-5B & 6A-6C).

In an embodiment, the styrene acrylic copolymer emulsion may comprise from about 1 weight percent to about 50 weight percent of butyl acrylate, ethyl acrylate, 2-ethylhexyl acrylate and the like, and any range or value there between. In an embodiment, the styrene acrylic copolymer emulsion may comprise about 11.40 weight percent of butyl acrylate, ethyl acrylate, 2-ethylhexyl acrylate and the like. (See e.g., FIGS. 5A-5B & 6A-6C).

In an embodiment, the styrene acrylic polymer emulsion may comprise from about 1 weight percent to about 10 weight percent of methyl acrylic acid, and any range or value there between. In an embodiment, the styrene acrylic copolymer emulsion may comprise about 2.3 weight percent of methyl acrylic acid. (See e.g., FIGS. 5A-5B & 6A-6C).

In an embodiment, the styrene acrylic copolymer emulsion may comprise from about 40 weight percent to about 80 weight percent of water, and any range or value there between. In an embodiment, the styrene acrylic copolymer emulsion may comprise about 62 weight percent of water. (See e.g., FIGS. 5A-5B & 6A-6C).

In an embodiment, the wood restorer may comprise from about 0.001 weight percent to about 5 weight percent of styrene polymer, and any range or value there between. (See e.g., FIGS. 5A-5B & 6A-6C). In an embodiment, the wood restorer may comprise about 0.8 weight percent of styrene polymer.

In an embodiment, the wood restorer may comprise from about 0.001 weight percent to about 5 weight percent of methyl methacrylate polymer, and any range or value there between. (See e.g., FIGS. 5A-5B & 6A-6C). In an embodiment, the wood restorer may comprise about 0.6 weight percent of methyl methacrylate polymer.

In an embodiment, the wood restorer may comprise from about 0.001 weight percent to about 1 weight percent of methyl acrylic acid, and any range or value there between. (See e.g., FIGS. 5A-5B & 6A-6C). In an embodiment, the wood restorer may comprise about 0.1 weight percent of methyl acrylic acid.

In an embodiment, the wood restorer may comprise from about 0.1 weight percent to about 10 weight percent of water (from the styrene acrylate copolymer emulsion), and any range or value there between. (See e.g., FIGS. 5A-5B & 6A-6C). In an embodiment, the wood restorer may comprise about 3.5 weight percent of water (from the styrene acrylate copolymer emulsion).

In an embodiment, the polyethylene wax emulsion may comprise a high density polyethylene wax, ethoxylated C12-C15 alcohols and water. (See e.g., FIGS. 5A-5B & 6A-6C).

In an embodiment, the polyethylene wax emulsion may comprise from about 1 weight percent to about 50 weight percent of a high density polyethylene wax, and any range or value there between. (See e.g., FIGS. 5A-5B & 6A-6C). In an embodiment, the polyethylene wax emulsion may comprise about 27.0 weight percent of a high density polyethylene wax.

In an embodiment, the polyethylene wax emulsion may comprise from about 5 weight percent to about 20 weight percent of one or more ethoxylated C12-C15 alcohol, and any range or value there between. (See e.g., FIGS. 5A-5B & 6A-6C). In an embodiment, the polyethylene wax emulsion may comprise about 8 weight percent of one or more ethoxylated C12-C15 alcohol.

In an embodiment, the polyethylene wax emulsion may comprise from about 40 weight percent to about 80 weight percent of water, and any range or value there between. (See e.g., FIGS. 5A-5B & 6A-6C). In an embodiment, the polyethylene wax emulsion may comprise about 65 weight percent of water.

In an embodiment, the wood restorer may comprise from about 0.001 weight percent to about 5 weight percent of a high density polyethylene wax, and any range or value there between. (See e.g., FIGS. 5A-5B & 6A-6C). In an embodiment, the wood restorer may comprise about 0.1 weight percent high density polyethylene wax.

In an embodiment, the wood restorer may comprise from about 0.001 weight percent to about 1 weight percent of one or more ethoxylated C12-C15 alcohol, and any range or value there between. (See e.g., FIGS. 5A-5B & 6A-6C). In an embodiment, the wood restorer may comprise about 0.03 weight percent of one or more ethoxylated C12-C15 alcohol.

In an embodiment, the wood restorer may comprise from about 0.001 weight percent to about 1 weight percent of water (from the high density polyethylene wax emulsion), and any range or value there between. (See e.g., FIGS. 5A-5B & 6A-6C). In an embodiment, the wood restorer may comprise about 0.03 weight percent of water (from the high density polyethylene wax emulsion).

Stain

In an embodiment, the wood restorer may comprise from about 0.2 weight percent to about 20 weight percent of a stain, and any range or value there between. In an embodiment, the wood restorer may comprise about 2.7 weight percent of a stain. (See e.g., FIG. 1). In an embodiment, the wood restorer may comprise about 1 weight percent of a stain. (See e.g., FIGS. 1 & 5A-6C). In an embodiment, the wood restorer may comprise about 0.7 weight percent of a stain. (See e.g., FIG. 3). In an embodiment, the wood restorer may comprise about 0.5 weight percent of a stain. (See e.g., FIG. 2).

The stain may be any suitable stain. For example, a suitable stain includes, but is not limited to, a Chromaflo™ 50-9400 series stain (see Table 1) or equivalent, a Chromaflo™ 50-990 series stain (see Table 2) or equivalent, and combinations thereof.

In an embodiment, the wood restorer may comprise a Chromaflo™ Black Stain (50-9410) or equivalent. (See e.g., FIGS. 1 & 3). In an embodiment, the Chromaflo™ Black Stain (50-9410) may comprise about 22.6 weight percent of black pigment, about 14.0 weight percent of resin, about 59 weight percent of water, and about 4.4 weight percent of volatile organic compounds. (See e.g., Table 1).

In an embodiment, the wood restorer may comprise a Chromaflo™ Brown Stain (50-990-40092R) or equivalent. (See e.g., FIGS. 2 & 5A-5B). In an embodiment, the Chromaflo™ Brown Stain (50-990-40092R) may comprise about 41.0 weight percent of brown pigment, about 6.7 weight percent of nonvolatiles, about 52.3 weight percent of water. (See e.g., Table 2).

In an embodiment, the wood restorer may comprise a Chromaflo™ Brown Stain (50-990-412658) or equivalent. (See e.g., FIGS. 4 & 6A-6C). In an embodiment, Chromaflo™ Brown Stain (50-990-412658) may comprise about 32.0 weight percent of brown pigment, about 8.0 weight percent of green pigment, about 20.0 weight percent of nonvolatiles, and about 40.0 weight percent of water.

In an embodiment, the wood restorer may comprise from about 0.001 to about 1 weight percent of pigment, and any range or value there between. In an embodiment, the wood restorer may comprise about 0.6 weight percent pigment. (See e.g., FIG. 1). In an embodiment, the wood restorer may comprise about 0.3 weight percent pigment. (See e.g., FIG. 4). In an embodiment, the wood restorer may comprise about 0.2 weight percent pigment. (See e.g., FIG. 2). In an embodiment, the wood restorer may comprise about 0.15 weight percent pigment. (See e.g., FIG. 3). In an embodiment, the wood restorer may comprise about 0.4 weight percent pigment. (See e.g., FIGS. 5A-5B). In an embodiment, the wood restorer may comprise about 0.38 weight percent pigment. (See e.g., FIGS. 6A-6C).

Water Balance

In an embodiment, the wood restorer may comprise from about 50 to about 98 weight percent of water, and any range or value there between. In an embodiment, the wood restorer may comprise about 71 weight percent or about 72.7 weight percent of water (not including any water from other components). (See e.g., FIGS. 1, 3-4 & 6A-6C). In an embodiment, the wood restorer may comprise about 88.2 weight percent of water (not including any water from other components). (See e.g., FIG. 2). In an embodiment, the wood restorer may comprise about 73.4 weight percent water. (See e.g., FIGS. 5A-5B).

The water may be any suitable water. For example, a suitable water includes, but is not limited to, distilled water, potable water, purified water, and combinations thereof. In an embodiment, the wood restorer comprises tap water. (See e.g., FIGS. 1 & 3-4). In an embodiment, the wood restorer comprises purified water. (See e.g., FIG. 2). In an embodiment, the wood restorer may comprise Omnova™ Purified Water. (See e.g., FIG. 2).

In an embodiment, the wood restorer may comprise from about 50 to about 98 weight percent of tap water and/or purified water, and any range or value there between. In an embodiment, the wood restorer may comprise about 71 weight percent or about 72.7 weight percent of tap water (not including any water from polymer emulsion). (See e.g., FIGS. 1, 3-4 & 6A-6C). In an embodiment, the wood restorer may comprise about 88.2 weight percent of purified water (not including any water from polymer emulsion). (See e.g., FIG. 2). In an embodiment, the wood restorer may comprise about 88.2 weight percent of Omnova™ Purified Water (not including any water from polymer emulsion). (See e.g., FIG. 2). In an embodiment, the wood restorer may comprise about 73.4 weight percent water. (See e.g., FIGS. 5A-5B).

Additives

In an embodiment, the wood restorer may further comprise one or more additives.

The additives may be any suitable additives. For example, suitable additives include, but are not limited to, any antibacterial agent, any defoamer, any flame retardant, any plasticizer, any fast-acting solvent, any surfactant, and combinations thereof. (See e.g., FIGS. 2 & 5A-6C).

In an embodiment, the wood restorer may further comprise an antibacterial agent. In an embodiment, the wood restorer may further comprise from about 0.001 weight percent to about 1 weight percent of an antibacterial agent, and any range or value there between. In an embodiment, the wood restorer may further comprise about 0.05 weight percent of an antibacterial agent.

The antibacterial agent may be any suitable antibacterial agent. For example, a suitable antibacterial agent includes, but is not limited to, a Proxel® GXL antibacterial agent or equivalent. In an embodiment, the wood restorer may further comprise from about 0.001 weight percent to about 1 weight percent of a Proxel® GXL antibacterial agent, and any range or value there between. In an embodiment, the wood restorer may further comprise about 0.05 weight percent of a Proxel® GXL antibacterial agent. (See e.g., FIG. 2).

In an embodiment, the antibacterial agent may comprise 1,2-benzisothiazolin-3-one, dipropylene glycol, sodium hydroxide and water. (See e.g., FIGS. 5A-6C).

In an embodiment, the antibacterial agent may comprise from about 1 weight percent to about 50 weight percent of 1,2-benzisothiazolin-3-one, and any range or value there between. (See e.g., FIGS. 5A-6C). In an embodiment, the antibacterial agent may comprise about 20 weight percent of 1,2-benzisothiazolin-3-one.

In an embodiment, the antibacterial agent may comprise from about 0.001 weight percent to about 5 weight percent of dipropylene glycol, and any range or value there between. (See e.g., FIGS. 5A-6C). In an embodiment, the antibacterial agent may comprise about 2 weight percent of dipropylene glycol.

In an embodiment, the antibacterial agent may comprise from about 1 weight percent to about 20 weight percent of sodium hydroxide, and any range or value there between. (See e.g., FIGS. 5A-6C). In an embodiment, the antibacterial agent may comprise about 8 weight percent of sodium hydroxide.

In an embodiment, the antibacterial agent may comprise from about 50 weight percent to about 99 weight percent of water, and any range or value there between. (See e.g., FIGS. 5A-6C). In an embodiment, the antibacterial agent may comprise about 70 weight percent of water.

In an embodiment, the wood restorer may comprise from about 0.001 weight percent to about 1 weight percent of 1,2-benzisothiazolin-3-one, and any range or value there between. (See e.g., FIGS. 5A-6C). In an embodiment, the wood restorer may comprise about <0.01 weight percent of 1,2-benzisothiazolin-3-one.

In an embodiment, the wood restorer may comprise from about 0.001 weight percent to about 1 weight percent of dipropylene glycol, and any range or value there between. (See e.g., FIGS. 5A-6C). In an embodiment, the wood restorer may comprise about <0.01 weight percent of dipropylene glycol.

In an embodiment, the wood restorer may comprise from about 0.001 weight percent to about 1 weight percent of sodium hydroxide, and any range or value there between. (See e.g., FIGS. 5A-6C). In an embodiment, the wood restorer may comprise about <0.01 weight percent of sodium hydroxide.

In an embodiment, the wood restorer may comprise from about 0.001 weight percent to about 1 weight percent of water (from the antibacterial agent), and any range or value there between. (See e.g., FIGS. 5A-6C). In an embodiment, the wood restorer may comprise about 0.01 weight percent of water (from the antibacterial agent).

In an embodiment, the wood restorer may further comprise a defoamer. In an embodiment, the wood restorer may further comprise from about 0.001 weight percent to about 1 weight percent of a defoamer, and any range or value there between. In an embodiment, the wood restorer may further comprise about 0.01 weight percent of a defoamer.

The antibacterial agent may be any suitable defoamer. For example, a suitable defoamer includes, but is not limited to, a Silfoam® SE-21 silicone defoamer or equivalent. In an embodiment, the wood restorer may further comprise from about 0.001 weight percent to about 1 weight percent of a Silfoam® SE-21 silicone defoamer, and any range or value there between. In an embodiment, the wood restorer may further comprise about 0.01 weight percent of a Silfoam® SE-21 silicone defoamer. (See e.g., FIG. 2).

In an embodiment, the defoamer may comprise polymethylsiloxane and water. (See e.g., FIGS. 5A-6C).

In an embodiment, the defoamer may comprise from about 1 weight percent to about 20 weight percent of polydimethylsiloxane, and any range or value there between. (See e.g., FIGS. 5A-6C). In an embodiment, the defoamer may comprise about 10 weight percent of polydimethylsiloxane.

In an embodiment, the defoamer may comprise from about 50 weight percent to about 99 weight percent of water, and any range or value there between. (See e.g., FIGS. 5A-6C). In an embodiment, the defoamer may comprise about 90 weight percent of water.

In an embodiment, the wood restorer may comprise from about 0.001 weight percent to about 1 weight percent of polydimethylsiloxane, and any range or value there between. (See e.g., FIGS. 5A-6C). In an embodiment, the wood restorer may comprise about <0.01 weight percent of polydimethylsiloxane.

In an embodiment, the wood restorer may comprise from about 0.001 weight percent to about 1 weight percent of water (from the defoamer), and any range or value there between. (See e.g., FIGS. 5A-6C). In an embodiment, the wood restorer may comprise from about <0.01 weight percent of water (from the defoamer).

In an embodiment, the wood restorer may further comprise a flame retardant. In an embodiment, the wood restorer may further comprise from about 0.1 weight percent to about 1.0 weight percent of a flame retardant, and any range or value there between. In an embodiment, the wood restorer may further comprise about 0.36 weight percent of a flame retardant. (See e.g., FIG. 2).

The flame retardant may be any suitable flame retardant. For example, a suitable flame retardant includes, but is not limited to, a KP-140 flame retardant or equivalent. In an embodiment, the wood restorer may further comprise from about 0.1 weight percent to about 1 weight percent of a KP-140 flame retardant, and any range or value there between. In an embodiment, the wood restorer may further comprise about 0.36 weight percent of a KP-140 flame retardant. (See e.g., FIG. 2).

In an embodiment, the flame retardant may comprise tris (2-butoxyethyl) phosphate. (See e.g., FIGS. 5A-6C).

In an embodiment, the flame retardant may comprise from about 0.001 weight percent to about 5 weight percent of tris (2-butoxyethyl) phosphate, and any range or value there between. (See e.g., FIGS. 5A-6C). In an embodiment, the flame retardant may comprise about 1.37 weight percent of tris (2-butoxyethyl) phosphate.

In an embodiment, the wood restorer may comprise from about 0.001 weight percent to about 1 weight percent of tris (2-butoxyethyl) phosphate, and any range or value there between. (See e.g., FIGS. 5A-6C). In an embodiment, the wood restorer may comprise about 0.36 weight percent of tris (2-butoxyethyl) phosphate.

In an embodiment, the wood restorer may further comprise a plasticizer. In an embodiment, the wood restorer may further comprise from about 0.1 weight percent to about 1 weight percent of a plasticizer, and any range or value there between. In an embodiment, the wood restorer may further comprise about 0.36 weight percent of a plasticizer. (See e.g., FIG. 2).

The plasticizer may be any suitable plasticizer. For example, a suitable plasticizer includes, but is not limited to, a Dow® Carbitol™ LP plasticizer or equivalent. In an embodiment, the wood restorer may further comprise from about 0.001 weight percent to about 1 weight percent of a Dow® Carbitol™ LP plasticizer, and any range or value there between. In an embodiment, the wood restorer may further comprise about 0.36 weight percent of a Dow® Carbitol™ LP plasticizer. (See e.g., FIG. 2).

In an embodiment, the plasticizer may comprise from about 0.001 weight percent to about 5 weight percent of diethylene glycol monoethyl ether, and any range or value there between. (See e.g., FIGS. 5A-6C). In an embodiment, the plasticizer may comprise about 1.45 weight percent of diethylene glycol monoethyl ether.

In an embodiment, the wood restorer may comprise from about 0.001 weight percent to about 1 weight percent of diethylene glycol monoethyl ether, and any range or value there between. (See e.g., FIGS. 5A-6C). In an embodiment, the wood restorer may comprise about 0.38 weight percent of diethylene glycol monoethyl ether.

In an embodiment, the wood restorer may further comprise a solvent. In an embodiment, the wood restorer may further comprise from about 0.001 weight percent to about 1 weight percent of a solvent, and any range or value there between. In an embodiment, the wood restorer may further comprise about 0.38 weight percent of a solvent. (See e.g., FIG. 2).

The solvent may be any suitable fact-acting solvent. For example, a suitable fast-acting solvent includes, but is not limited to, a Dow® Carbitol™ LG fast-acting solvent or equivalent. In an embodiment, the wood restorer may further comprise from about 0.001 weight percent to about 1 weight percent of a Dow® Carbitol™ LG fast-acting solvent, and any range or value there between. In an embodiment, the wood restorer may further comprise about 0.38 weight percent of a Dow® Carbitol™ LG fast-acting solvent. (See e.g., FIG. 2).

In an embodiment, the solvent may comprise from about 0.001 weight percent to about 5 weight percent of diethylene glycol monoethyl ether, and any range or value there between. (See e.g., FIGS. 5A-6C). In an embodiment, the solvent may comprise about 1.45 weight percent of diethylene glycol monoethyl ether.

In an embodiment, the wood restorer may comprise from about 0.001 weight percent to about 1 weight percent of diethylene glycol monoethyl ether, and any range or value there between. (See e.g., FIGS. 5A-6C). In an embodiment, the wood restorer may comprise about 0.38 weight percent of diethylene glycol monoethyl ether.

In an embodiment, the wood restorer may further comprise a surfactant. In an embodiment, the wood restorer may further comprise from about 0.001 weight percent to about 1 weight percent of a surfactant, and any range or value there between. In an embodiment, the wood restorer may further comprise about 0.01 weight percent of a surfactant. (See e.g., FIG. 2).

The surfactant may be any suitable perfluorosurfactant wetting agent. For example, a suitable surfactant includes, but is not limited to, a Omnova™ Polyfox™ PF-2003 surfactant or equivalent. In an embodiment, the wood restorer may further comprise from about 0.001 weight percent to about 1 weight percent of a Omnova™ Polyfox™ PF-2003 surfactant, and any range or value there between. In an embodiment, the wood restorer may further comprise about 0.01 weight percent of an Omnova™ Polyfox™ PF-2003 surfactant. (See e.g., FIG. 2).

In an embodiment, the surfactant may comprise active anionic fluorinated polyether diammonium, dipropylene glycol methyl ether, diethylene glycol monobutyl ether and water. (See e.g., FIGS. 5A-6C).

In an embodiment, the surfactant may comprise from about 1 weight percent to about 60 weight percent of active anionic fluorinated polyether diammonium, and any range or value there between. (See e.g., FIGS. 5A-6C). In an embodiment, the surfactant may comprise about 30 weight percent of active anionic fluorinated polyether diammonium.

In an embodiment, the surfactant may comprise from about 1 weight percent to about 30 weight percent of dipropylene glycol methyl ether, and any range or value there between. (See e.g., FIGS. 5A-6C). In an embodiment, the surfactant may comprise about 15 weight percent of dipropylene glycol methyl ether.

In an embodiment, the surfactant may comprise from about 1 weight percent to about 30 weight percent of diethylene glycol monobutyl ether, and any range or value there between. (See e.g., FIGS. 5A-6C). In an embodiment, the surfactant may comprise about 15 weight percent of diethylene glycol monobutyl ether.

In an embodiment, the surfactant may comprise from about 20 weight percent to about 80 weight percent of water, and any range or value there between. (See e.g., FIGS. 5A-6C). In an embodiment, the surfactant may comprise about 40 weight percent of water.

In an embodiment, the wood restorer may comprise from about 0.001 weight percent to about 1 weight percent of active anionic fluorinated polyether diammonium, and any range or value there between. (See e.g., FIGS. 5A-6C). In an embodiment, the surfactant may comprise about 0.08 weight percent of active anionic fluorinated polyether diammonium.

In an embodiment, the wood restorer may comprise from about 0.001 weight percent to about 1 weight percent of dipropylene glycol methyl ether, and any range or value there between. (See e.g., FIGS. 5A-6C). In an embodiment, the wood restorer may comprise about 0.04 weight percent of dipropylene glycol methyl ether.

In an embodiment, the wood restorer may comprise from about 0.001 weight percent to about 1 weight percent of diethylene glycol monobutyl ether, and any range or value there between. (See e.g., FIGS. 5A-6C). In an embodiment, the wood restorer may comprise about 0.4 weight percent of diethylene glycol monobutyl ether.

In an embodiment, the surfactant may comprise from about 0.001 weight percent to about 1 weight percent of water, and any range or value there between. (See e.g., FIGS. 5A-6C). In an embodiment, the wood restorer may comprise about 0.11 weight percent of water (from the surfactant).

### Example 6 (with a Brown and Green Pigment)

FIGS. 6A-6C illustrate a composition of a wood restorer with a stain comprising about 0.31 weight percent of a brown pigment and about 0.08 weight percent of a green pigment (Example 6).

Stain

In an embodiment, the wood restorer may comprise from about 0.2 weight percent to about 20 weight percent of a stain, and any range or value there between. In an embodiment, the wood restorer may comprise about 2.7 weight percent of a stain. (See e.g., FIG. 1). In an embodiment, the wood restorer may comprise about 1 weight percent of a stain. (See e.g., FIGS. 1 & 5A-6C). In an embodiment, the wood restorer may comprise about 0.7 weight percent of a stain. (See e.g., FIG. 3). In an embodiment, the wood restorer may comprise about 0.5 weight percent of a stain. (See e.g., FIG. 2).

The stain may be any suitable stain. For example, a suitable stain includes, but is not limited to, a Chromaflo™ 50-9400 series stain (see Table 1) or equivalent, a Chromaflo™ 50-990 series stain (see Table 2) or equivalent, and combinations thereof.

In an embodiment, the wood restorer may comprise a Chromaflo Black Stain (50-9410) or equivalent. (See e.g., FIGS. 1 & 3). In an embodiment, the Chromaflo Black Stain (50-9410) may comprise about 22.6 weight percent of black pigment, about 14.0 weight percent of resin, about 59 weight percent of water, and about 4.4 weight percent of volatile organic compounds. (See e.g., Table 1).

In an embodiment, the wood restorer may comprise a Chromaflo Brown Stain (50-990-40092R) or equivalent. (See e.g., FIGS. 2 & 5A-5B). In an embodiment, the Chromaflo Brown Stain (50-990-40092R) may comprise about 41.0 weight percent of brown pigment, about 6.7 weight percent of nonvolatiles, about 52.3 weight percent of water. (See e.g., Table 2).

In an embodiment, the wood restorer may comprise a Chromaflo Brown Stain (50-990-412658) or equivalent. (See e.g., FIGS. 4 & 6A-6C). In an embodiment, Chromaflo Brown Stain (50-990-412658) may comprise about 32.0 weight percent of brown pigment, about 8.0 weight percent of green pigment, about 20.0 weight percent of nonvolatiles, and about 40.0 weight percent of water.

In an embodiment, the wood restorer may comprise from about 0.001 to about 1 weight percent of pigment, and any range or value there between. In an embodiment, the wood restorer may comprise about 0.6 weight percent pigment. (See e.g., FIG. 1). In an embodiment, the wood restorer may comprise about 0.3 weight percent pigment. (See e.g., FIG. 4). In an embodiment, the wood restorer may comprise about 0.2 weight percent pigment. (See e.g., FIG. 2). In an embodiment, the wood restorer may comprise about 0.15 weight percent pigment. (See e.g., FIG. 3). In an embodiment, the wood restorer may comprise about 0.4 weight percent pigment. (See e.g., FIGS. 5A-5B). In an embodiment, the wood restorer may comprise about 0.38 weight percent pigment. (See e.g., FIGS. 6A-6C).

In an embodiment, the stain may comprise a glycol ether solvent, an acrylic latex emulsion mineral oil/polyol, an alcohol ethoxylate surfactant, a polymeric dispersant, a Green 7 pigment, a Brown 23 pigment, an amine, a biocide, a defoamer and water. (See e.g., FIGS. 6A-6C).

In an embodiment, the stain may comprise from about 0.001 weight percent to about 1 weight percent of glycol ether solvent, and any range or value there between. (See e.g., FIGS. 6A-6C). In an embodiment, the stain may comprise about 0.4 weight percent of glycol ether solvent.

In an embodiment, the stain may comprise from about 0.5 weight percent to about 20 weight percent of acrylic latex emulsion mineral oil/polyol, and any range or value there between. (See e.g., FIGS. 6A-6C). In an embodiment, the stain may comprise about 9.8 weight percent of acrylic latex emulsion mineral oil/polyol.

In an embodiment, the stain may comprise from about 0.001 weight percent to about 5 weight percent of alcohol ethoxylate surfactant, and any range or value there between. (See e.g., FIGS. 6A-6C). In an embodiment, the stain may comprise about 0.9 weight percent of alcohol ethoxylate surfactant.

In an embodiment, the stain may comprise from about 0.2 weight percent to about 20 weight percent of polymeric dispersant, and any range or value there between. (See e.g., FIGS. 6A-6C). In an embodiment, the stain may comprise about 7.4 weight percent of polymeric dispersant.

In an embodiment, the stain may comprise from about 0.2 weight percent to about 20 weight percent of Green 7 pigment, and any range or value there between. (See e.g., FIGS. 6A-6C). In an embodiment, the stain may comprise about 8 weight percent of Green 7 pigment.

In an embodiment, the stain may comprise from about 0.5 weight percent to about 50 weight percent of Brown 23 pigment, and any range or value there between. (See e.g., FIGS. 6A-6C). In an embodiment, the stain may comprise about 32 weight percent of Brown 23 pigment.

In an embodiment, the stain may comprise from about 0.001 weight percent to about 5 weight percent of amine, and any range or value there between. (See e.g., FIGS. 6A-6C). In an embodiment, the stain may comprise about 0.5 weight percent of amine.

In an embodiment, the stain may comprise from about 0.001 weight percent to about 5 weight percent of biocide, and any range or value there between. (See e.g., FIGS. 6A-6C). In an embodiment, the stain may comprise about 0.4 weight percent of biocide.

In an embodiment, the stain may comprise from about 0.001 weight percent to about 1 weight percent of defoamer, and any range or value there between. (See e.g., FIGS. 6A-6C). In an embodiment, the stain may comprise about 0.06 weight percent of defoamer.

In an embodiment, the stain may comprise from about 20 weight percent to about 80 weight percent of water, and any range or value there between. (See e.g., FIGS. 6A-6C). In an embodiment, the stain may comprise about 40 weight percent of water.

Method of Using a Wood Restorer with a Stain

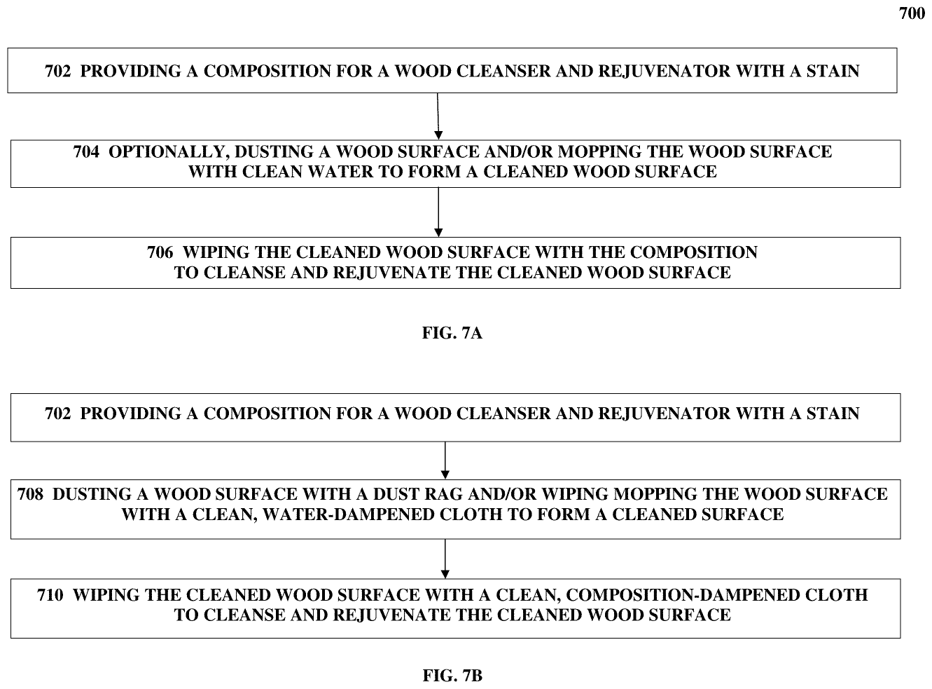

FIGS. 7A-7B illustrate a method of using a wood restorer with a stain to cleanse and rejuvenate a wood surface.

As shown in FIG. 7A, a method of using a composition for a wood restorer with a stain to cleanse and rejuvenate a wood surface, the method comprises:

a) providing a composition 702, as discussed herein;
b) optionally, dusting a wood surface and/or mopping the wood surface with clean water to form a cleaned wood surface 704; and
c) wiping the cleaned wood surface with the composition to cleanse and rejuvenate the cleaned wood surface 706.

In an embodiment, a method of using a composition for a wood restorer with a stain to cleanse and rejuvenate a wood surface, the method comprises:

a) providing a composition 702, as discussed herein;
b) dusting a wood surface and/or mopping the wood surface with clean water to form a cleaned wood surface 704; and
c) wiping the cleaned wood surface with the composition to cleanse and rejuvenate the cleaned wood surface 706. (See e.g., FIG. 7A).

In an embodiment, step b) may comprise dusting the wood surface with a dust rag and/or wiping mopping the wood surface with a clean, water-dampened cloth to form the cleaned surface 708. (See e.g., FIG. 7B).

In an embodiment, step c) may comprise wiping the cleaned wood surface with a clean, composition-dampened cloth to cleanse and rejuvenate the cleaned wood surface 710. (See e.g., FIG. 7B).

In an embodiment, the wood surface may have a scratch. In an embodiment, the composition reduces the appearance of the scratch.

Sample 1

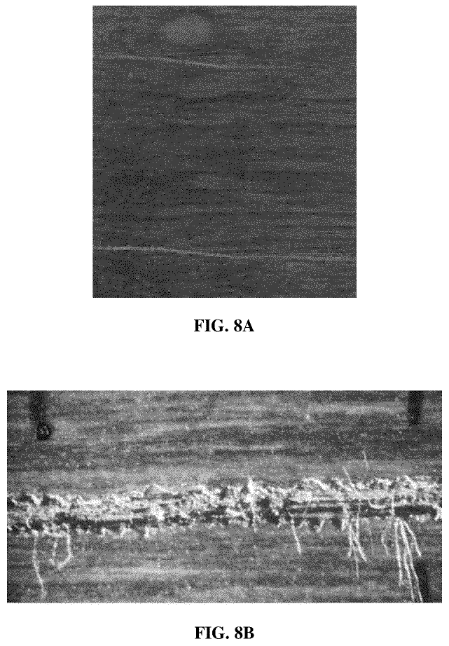

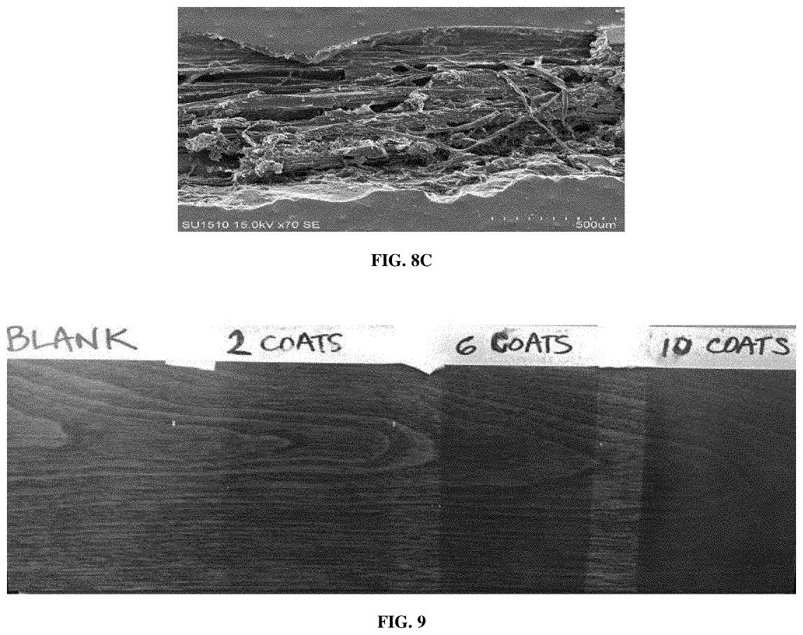

FIG. 8A illustrates a photograph of a wood surface with a scratch (sample 1) after using a composition of a wood restorer with a stain; FIG. 8B illustrates a magnified image of the scratch of FIG. 8A; and FIG. 8C illustrates a scanning electron microscope (SEM) image of the scratch of FIGS. 8A-8B, all showing a reduction in appearance of the scratch. The composition is shown in FIGS. 6A-6C.

The Gardner gloss was measured after applying two coats of the composition of a wood restorer. (See Table 3).

TABLE 3

| Gardner Gloss | Sample 1 (2 Coats) |
|---|---|
| 20° Gloss | 6.2 ± 1.2 |
| 60° Gloss | 38.8 ± 4.0 |
| 85° Gloss | 54.0 ± 7.0 |

Sample 2

FIG. 9 illustrates a wood surface before and after repeatedly using a composition of a wood restorer with a stain. The composition is shown in FIGS. 6A-6C.

The Gardner gloss was measured before applying zero coats of the composition of a wood restorer, and after two coats, after six coats and after 10 coats of the composition. (See Table 4).

TABLE 4

| | Sample 2 | Sample 2 | Sample 2 | Sample 2 |
|---|---|---|---|---|
| Gardner Gloss | (0 Coats) | (2 Coats) | (6 Coats) | (10 Coats) |
| 20° Gloss | 5.1 ± 0.7 | 7.1 ± 0.5 | 20.5 ± 2.5 | 32.0 ± 2.9 |
| 60° Gloss | 24.7 ± 1.5 | 32.5 ± 1.3 | 59.2 ± 4.2 | 72.7 ± 2.4 |
| 85° Gloss | 29.1 ± 0.8 | 42.0 ± 1.9 | 71.1 ± 4.1 | 82.1 ± 2.5 |

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims. The invention is specifically intended to be as broad as the claims below and their equivalents.

### Definitions

As used herein, the terms “a,” “an,” “the,” and “said” means one or more, unless the context dictates otherwise.

As used herein, the term “about” means the stated value plus or minus a margin of error or plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

What is claimed is:

1. A composition for a wood restorer with a stain, the composition comprising:
a) a polymer emulsion, wherein the polymer emulsion comprises:
i) a styrene acrylic copolymer emulsion; and
ii) a high density polyethylene emulsion;
b) a stain; and
c) a first water, wherein the first water forms the balance of the composition.

2. The composition of claim 1, further comprising:
a) from about 1 weight percent to about 50 weight percent of the polymer emulsion;
b) from about 0.1 weight percent to about 10 weight percent of the stain; and
d) from about 50 weight percent to about 99 weight percent of the first water.

3. The composition of claim 2, wherein the from about 1 weight percent to about 50 weight percent of polymer emulsion comprises:
a) from about 1 weight percent to about 45 weight percent of the styrene acrylic copolymer emulsion; and
b) from about 0.5 weight percent to about 5 weight percent of a high density polyethylene wax emulsion.

4. The composition of claim 2, wherein
a) the styrene acrylic copolymer emulsion comprises:
i) from about 1 weight percent to about 30 weight percent of styrene polymer;
ii) from about 1 weight percent to about 30 weight percent of methyl methacrylate polymer;
iii) from about 1 weight percent to about 30 weight percent of butyl acrylate, ethyl acrylate, 2-ethylhexyl acrylate, and combinations thereof;
iv) from 0.5 weight percent to about 5 weight percent of methyl acrylic acid; and
v) from about 50 weight percent to about 80 weight percent of second water; and
b) the high density polyethylene wax emulsion comprises:
i) from about 5 weight percent to about 60 weight percent of a high density polyethylene wax;
ii) from about 1 weight percent to about 20 weight percent of one or more ethoxylated C12-C15 alcohols; and
iii) from about 50 weight percent to about 80 weight percent of a third water.

5. The composition of claim 1, wherein the stain comprises a pigment.

6. The composition of claim 2, wherein the stain comprises from about 0.001 weight percent to about 1 weight percent of a pigment.

7. The composition of claim 1, wherein the stain comprises a white pigment, a black pigment, a phthalo blue pigment, a phthalo green pigment, an azo yellow pigment, a trans yellow oxide pigment, a yellow iron oxide pigment, a red iron oxide pigment, a trans red oxide pigment, a naphthol red pigment, a perylene red pigment, a quindo red pigment, and combinations thereof.

8. The composition of claim 1, wherein the stain comprises a black pigment, a brown pigment, a green pigment, and combinations thereof.

9. The composition of claim 1, wherein the stain comprises a brown pigment.

10. The composition of claim 1, wherein the first water is selected from the group consisting of distilled water, potable water, purified water, tap water, well water, and combinations thereof.

11. The composition of claim 1 further comprising an additive selected from the group consisting of an antibacterial agent, a defoamer, a fast-acting solvent, a flame retardant, a plasticizer, a surfactant and combinations thereof.

12. The composition of claim 2, wherein the polymer emulsion further comprises:
a) from about 0.5 weight percent to about 5 weight percent of a surfactant.

13. The composition of claim 2 further comprising:
d) from about 0.001 weight percent to about 0.5 weight percent of a surfactant.

14. The composition of claim 13, wherein the surfactant comprises:
a) from about 5 weight percent to about 50 weight percent of an active anionic fluorinated polyether diammonium;
b) from about 3 weight percent to about 30 weight percent of dipropylene glycol methyl ether;
c) from about 3 weight percent to about 30 weight percent of diethylene glycol monobutyl ether; and
d) from about 20 weight percent to about 60 weight percent of a fourth water.

15. The composition of claim 1 further comprising a defoamer.

16. The composition of claim 1 further comprising a defoamer, wherein the defoamer comprises polymethylsiloxane.

17. The composition of claim 1 further comprising a flame retardant.

18. The composition of claim 1 further comprising a flame retardant, wherein the flame retardant comprises tris (2-butoxyethyl) phosphate.

19. The composition of claim 1 further comprising a plasticizer.

20. The composition of claim 1 further comprising a plasticizer, wherein the plasticizer comprises diethylene glycol monoethyl ether.

21. The composition of claim 1 further comprising a fast-acting solvent.

22. The composition of claim 1 further comprising a fast-acting solvent, wherein the fast-acting solvent comprises diethylene glycol monoethyl ether.

23. A method of using a composition for a wood restorer with a stain, the method comprising:
a) providing the composition of claim 1;
b) dusting a wood surface and/or mopping the wood surface with clean water to form a cleaned wood surface; and
c) wiping the cleaned wood surface with the composition to cleanse and rejuvenate the cleaned wood surface.

24. The method of claim 23, wherein step b) comprises dusting the wood surface with a dust rag and/or wiping mopping the wood surface with a clean, water-dampened cloth to form the cleaned surface.

25. The method of claim 23, wherein step c) comprises wiping the cleaned wood surface with a clean, composition-dampened cloth to cleanse and rejuvenate the cleaned wood surface.

26. The method of claim 23, wherein the wood surface has a scratch and wherein the composition reduces the appearance of the scratch.

27. A method of using a composition for a wood restorer with a stain, the method comprising:
a) providing the composition of claim 2;
b) sweeping a wood surface and/or mopping the wood surface with clean water to form a cleaned wood surface; and
c) wiping the cleaned wood surface with the composition to cleanse and rejuvenate the cleaned wood surface.

28. The method of claim 27, wherein step b) comprises sweeping the wood surface with a broom or a dust rag and/or wiping mopping the wood surface with a clean, water-dampened cloth or mop to form the cleaned wood surface.

29. The method of claim 27, wherein step c) comprises wiping the cleaned wood surface with a clean, composition-dampened cloth or mop to cleanse and rejuvenate the cleaned wood surface.

30. The method of claim 27, wherein the wood surface has a scratch and wherein the composition reduces the appearance of the scratch.
